(19) United States
(12) Patent Application Publication
(10) Pub. No.: US 2002/0116238 A1
(43) Pub. Date: Aug. 22, 2002

(54) Method, system and storage medium for obtaining certificates of analysis

(76) Inventors: Jennifer Ann Himes, Hudson, OH (US); Sven Hendrikus Johan Verbroekken, Pittsfield, MA (US)

Correspondence Address: CANTOR COLBURN, LLP, 55 GRIFFIN ROAD SOUTH, BLOOMFIELD, CT, 06002

(21) Appl. No.: 09/777,530

(22) Filed: Feb. 6, 2001

(51) Int. Cl. G06F 17/60

(52) U.S. Cl. 705/7

(57) ABSTRACT

An exemplary embodiment of the invention is a method of obtaining certificate of analysis data from a supplier providing a deliverable to a customer. The method includes receiving at a customer system a request to submit certificate of analysis data corresponding to a deliverable. The certificate of analysis data corresponding to said deliverable is obtained by the customer system. The certificate of analysis data is compared to a predefined specification and delivery of the deliverable to the customer is authorized in response to the comparison. A system and storage medium for implementing the method are also disclosed.

### BACKGROUND OF THE INVENTION

The invention relates to a method, system and storage medium for obtaining certificates of analysis. In many industries, purchasers of goods and/or services require these deliverables to meet certain requirements. For example, a purchaser of raw materials for a manufacturing process needs the raw materials to meet certain predefined specifications. A purchaser of a service (e.g., metal treating) may need the service to be performed to a certain specification (e.g., annealed at a predefined temperature).

Typically, the purchaser must determine whether a deliverable meets predefined specifications in order to accept delivery. For example, a raw material provided to a manufacturer may need to be tested to confirm that the raw material meets specifications prior to formally accepting the shipment. Acceptance of services may also require analysis to confirm that the services were rendered according to predefined specifications. The need to confirm compliance with predefined specifications creates several drawbacks. The received deliverable typically remains in a receiving area until it is confirmed that the predefined specifications have been met. This is burdensome on the purchaser who must provide ample space to house the deliverable. In addition, the testing to confirm compliance with specifications is time consuming and often results in deliverables being returned to the supplier. This leads to delays which can be detrimental in time sensitive applications such as manufacturing. Thus, there is a need for a system for obtaining certificates of analysis indicating that a deliverable meets a specification before the deliverable is provided to the customer.

### BRIEF SUMMARY OF THE INVENTION

An exemplary embodiment of the invention is a method of obtaining certificate of analysis data from a supplier providing a deliverable to a customer. The method includes receiving at a customer system a request to submit certificate of analysis data corresponding to a deliverable. The certificate of analysis data corresponding to the deliverable is obtained by the customer system. The certificate of analysis data is compared to a predefined specification and delivery of the deliverable to the customer is authorized in response to the comparison. A system and storage medium for implementing the method are also disclosed.

### BRIEF DESCRIPTION OF THE DRAWINGS

Referring now to the drawings, wherein like elements are numbered alike in the several Figures:

FIG. 1 is a block diagram of an exemplary system for obtaining certificates of analysis;

FIG. 2 is a flowchart of an exemplary process for obtaining certificates of analysis;

FIG. 3 depicts an exemplary user interface for entering deliverable information; and

FIG. 4 depicts an exemplary user interface for entering certificate of analysis information.

### DETAILED DESCRIPTION

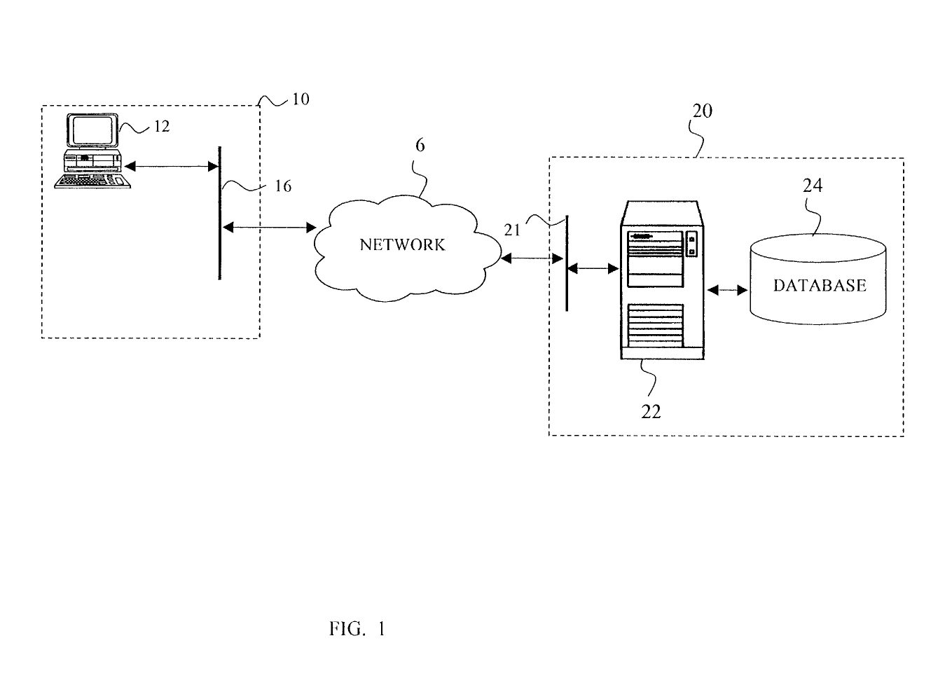

FIG. 1 is a block diagram of an exemplary system for providing certificates of analysis. The system of FIG. 1 includes a supplier 10 that is supplying a deliverable (e.g., goods or services) to a customer 20. To facilitate acceptance of the deliverable, the supplier provides a certificate of analysis indicating that the deliverable meets certain specifications defined by the customer. The certificate of analysis is provided electronically via network 6 prior to providing the deliverable to the customer. In an exemplary embodiment, the supplier 10 provides raw materials to the customer 20 used in a manufacturing process. The certificate of analysis provided by the supplier 10 guarantees that the deliverable meets predefined specifications and facilitates receipt of the deliverable by the customer 20. As described herein, during the process of submitting a certificate of analysis, a machine readable indicia is generated which facilitates receipt of a deliverable by the customer 20.

Typically, the supplier 10 includes one or more supplier systems 12 coupled to a network 6 through a firewall 16. The supplier system 12 may be implemented using a general-purpose computer executing a computer program for carrying out the processes described herein. Alternatively, supplier system 12 may be implemented using a device programmed primarily for accessing network 6 such as a network computer. The supplier system 12 may be coupled to network 6 in a wireless manner. The network 6 may be any type of known network including a wide area network (WAN), secure network (e.g., extranet, virtual private network), global network (e.g., Internet), etc. In a preferred embodiment, the network 6 is the Internet and each supplier system 12 executes a user interface application (e.g., web browser) to contact the customer 20 through the network 6. Certificates of analysis sent to customer 20 may be encrypted to enhance security.

The customer 20 includes a customer system 22 and a database 24. The customer system 22 is coupled to network 6 through a firewall 21. The customer system 22 may be coupled to network 6 in a wireless manner. The database 24 may be part of customer system 22 or a separate physical device accessible by customer system 22. In addition, the database 24 may be implemented using multiple devices such as existing, legacy databases. The customer system 22 may be implemented using one or more commercially available servers executing computer programs to implement the processes described herein. The customer system 22 acts as a database server to store and retrieve information in database 24. The customer system 22 also acts as a network server to interact with supplier 10. The customer system 22 also acts as an applications server executing a computer program to perform functions described herein. It is understood that the customer system 22 may be implemented by more than one physical device, such as a number of servers each performing one or more of the functions described herein.

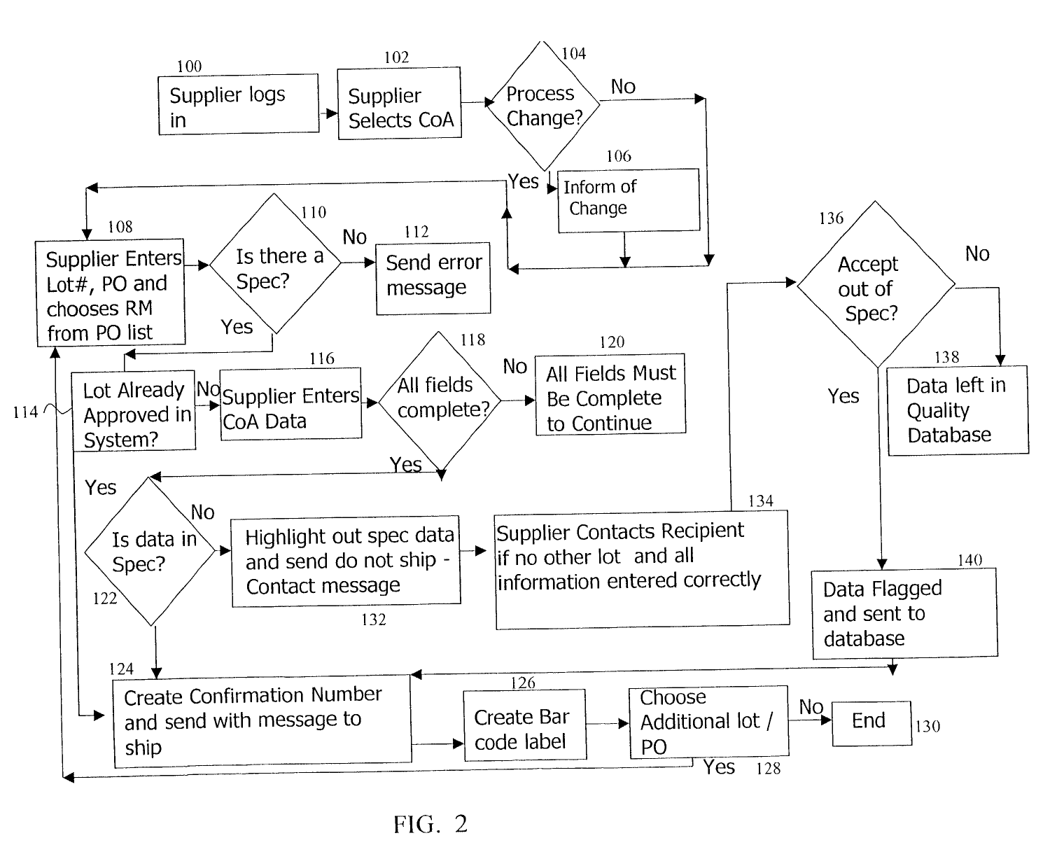

Operation of the system will now be described with reference to FIGS. 2-4. The process is described with reference to a supplier providing raw material used in a manufacturing process such as the manufacturing of plastic. It is understood that the invention may be used in other applications where obtaining certificates of analysis is performed prior to providing a deliverable.

FIG. 2 is a flow chart illustrating an exemplary process for providing a certificate of analysis. At step 100, a supplier contacts the customer system 22 to submit a certificate of analysis (CoA) as shown at step 102. At step 104, the customer system 22 queries the supplier whether the supplier's process for manufacturing the deliverable has changed or whether there has been a change in manufacturing location. If the supplier answers yes to either question, the process flows to step 106 where the supplier is prompted to describe the nature of the changes. Such changes often affect the deliverable. Notifying the customer of such changes allows the customer to evaluate the changes and notify the supplier if such changes are acceptable.

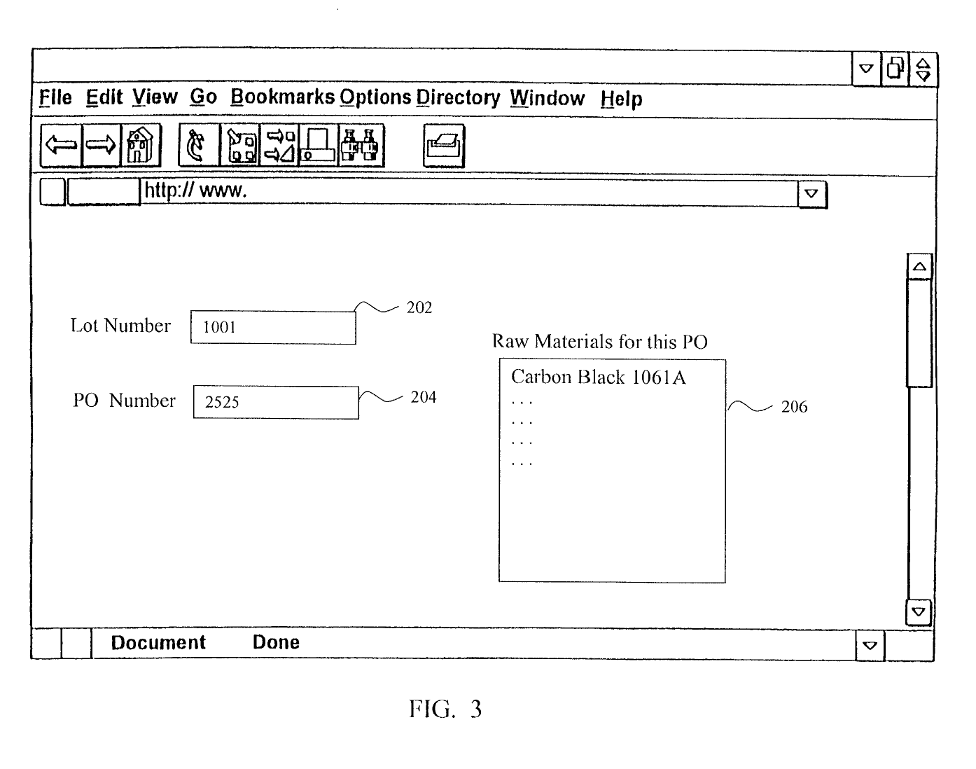

If the supplier responds that no changes have occurred at step 104, flow proceeds to step 108 where the supplier is prompted to enter a lot number and purchase order (PO) number corresponding to the order the supplier desires to fill. FIG. 3 depicts an exemplary user interface that allows the supplier to enter the lot number through lot number field 202 and purchase order number through purchase order number field 204. The lot number identifies the supplier's lot number of the material to be provided to the customer. The PO number is the customer's identifier of the items requested from the supplier 10. Once the supplier enters the lot number and purchase order number, a list of raw materials (RM) 206 is provided to the supplier. Based on the purchase order number, the customer system 22 accesses database 24 and retrieves raw materials requested in the corresponding purchase order. The supplier then selects a raw material from raw material list 206 for which the supplier is submitting a certificate of analysis.

Once the supplier selects a raw material, the customer system 22 determines if a specification for the raw material exists in database 24 at step 110. The specification is the customer's specification of properties that the raw material must meet to be accepted. If no specification exists for the raw material, flow proceeds to step 112 where an error message is generated. The customer must then determine why database 24 lacks a specification for one of the raw materials in raw material list 206.

If a specification exists, flow proceeds to step 114 where it is determined whether the lot number provided by the supplier is already an approved material for the raw material selected from the raw material list 206. Raw materials are typically made in lots identified by a lot number. If a raw material from a lot has been approved, then there is no reason to require the supplier to re-certify the material. In this scenario, the customer system 22 retrieves the material data from database 24, presents the material data to the supplier and asks for confirmation that the material data is accurate. If the supplier confirms that the material data is accurate, flow proceeds to step 124 described herein.

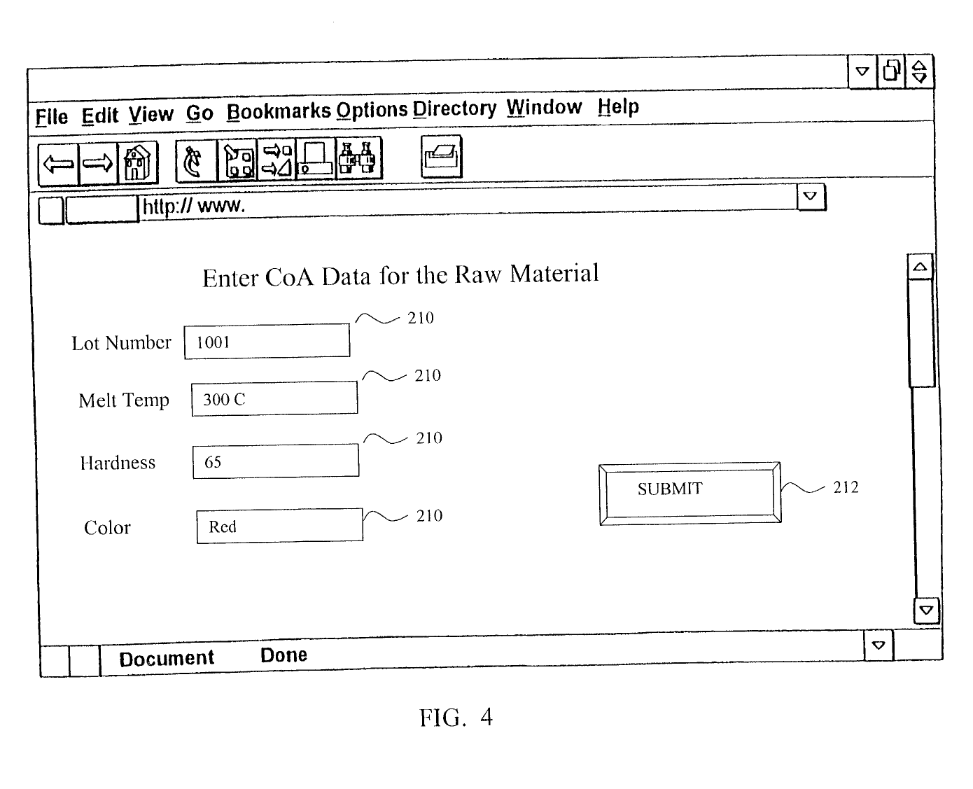

If the lot number does not correspond to an already approved lot stored in database 24, flow proceeds to step 116 where the supplier enters certificate of analysis data. The certificate of analysis data may define a number of properties of the material such as chemical make-up, physical properties, performance properties, etc. FIG. 4 depicts an exemplary interface through which the supplier enters the certificate of analysis data. Fields 210 allow the supplier to enter the certificate of analysis data. Once the fields are complete, the supplier sends the certificate of analysis data to the customer system 22 over network 6 by selecting the submit icon 212.

The customer system 22 checks that all fields 210 have been completed at step 118 and notifies the supplier of missing information at step 120. Once all fields 210 are complete, flow proceeds to step 122 where the customer system 22 compares the submitted certificate of analysis data to a specification stored in database 24. Typically, a specification will contain ranges, maximums and/or minimums for properties of the deliverable. The customer system 22 determines whether the certificate of analysis data meets the specified ranges, maximums, minimums, etc. If the submitted certificate of analysis data meets the specification, or if the lot number is already certified at step 114, flow proceeds to step 124 where a confirmation number is generated and a message is sent over network 6 to the supplier 10 to ship the raw material.

A machine readable indicia (e.g., a bar code label) is generated at step 126 and presented to the supplier system 12 over network 6. The supplier can print the bar code label and include the bar code label along with the physical shipment of raw material. This allows the customer to scan the bar code label upon receipt of the raw material and confirm that the raw material meets the customer's specifications. This allows incoming shipments of raw materials to be promptly distributed throughout the customer's manufacturing facility. The process can be repeated through step 128 or ended at step 130.

If at step 122 the certificate of analysis data does not meet the specification, flow proceeds to step 132 where the properties failing to meet the specification are highlighted presented to supplier system 12 over network 6. The supplier is instructed not to send the material and to contact the customer. At step 134, the supplier confirms that all the certificate of analysis data was entered correctly and no other lots of raw material are available. The customer decides at step 136 whether to accept the raw material that is out of specification. If the customer refuses to accept the raw material, flow proceeds to step 138 where the certificate of analysis data is stored in database 24 and the process ends.

If the customer decides to receive the material despite it not meeting the predefined specification, flow proceeds to step 140 where the data is flagged as out-of-specification data and stored in database 24. Flagging such data may allow the customer to track supplier performance. For example, a supplier who frequently provides out-of-specification material can be detected. Flow proceeds to step 124 as described above.

The system and method described above allows a customer to establish that a shipment of materials complies with predefined specifications prior to shipment of the materials. This reduces returns of materials and expedites distribution of the materials through a manufacturing facility.

As described above, the present invention can be embodied in the form of computer-implemented processes and apparatuses for practicing those processes. The present invention can also be embodied in the form of computer program code containing instructions embodied in tangible media, such as floppy diskettes, CD-ROMS, hard drives, or any other computer-readable storage medium, wherein, when the computer becomes an apparatus for practicing the invention. The present invention can also be embodied in the form of computer code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the essential scope thereof. Therefore, it is intended that the invention not be limited to the particular embodiments disclosed for carrying out the invention, but that the invention will include all embodiments falling within the scope of the appended claims.

What is claimed is:

1. A method of obtaining certificate of analysis data from a supplier providing a deliverable to a customer, the method comprising:
receiving at a customer system, via a network, a request to submit certificate of analysis data corresponding to said deliverable;
obtaining certificate of analysis data corresponding to said deliverable;
comparing said certificate of analysis data to a predefined specification stored in a database; and,
authorizing delivery of said deliverable to said customer in response to said comparing.

2. The method of claim 1 further comprising:
receiving a lot number identifying said deliverable;
wherein said obtaining certificate of analysis data includes determining if said lot number corresponds to an already approved lot number; and
wherein said authorizing delivery of said deliverable occurs if said lot number corresponds to an already approved lot number.

3. The method of claim 1 wherein:
said obtaining certificate of analysis data includes prompting said supplier to provide said certificate of analysis data.

4. The method of claim 1 further comprising:
providing a machine readable indicia to said supplier upon authorizing delivery of said deliverable.

5. The method of claim 4 wherein said machine readable indicia is a bar code.

6. The method of claim 4 wherein further comprising:
reading said machine readable indicia upon receipt of said deliverable to confirm that said deliverable meets said predefined specification.

7. The method of claim 1 wherein said deliverable is a good.

8. The method of claim 7 wherein said good is a raw material used in a manufacturing process.

9. The method of claim 1 wherein said deliverable is a service.

10. The method of claim 1 further comprising:
authorizing delivery of said deliverable if said certificate of analysis data does not meet said predefined specification and storing said certificate of analysis data as out-of-specification data.

11. The method of claim 1 further comprising:
receiving a purchase order number;
providing a list of deliverables to the supplier in response to the purchase order number;
receiving a deliverable selected by the supplier from the list of deliverables;
retrieving said predefined specification in response to said deliverable selected by the supplier.

12. A method of providing certificate of analysis data from a supplier of a deliverable to a customer, the method comprising:
accessing a customer system, via a network, to request submission of certificate of analysis data corresponding to said deliverable;
submitting certificate of analysis data corresponding to said deliverable;
receiving notification from said customer via the network that said certificate of analysis data meets a predefined specification; and,
delivering said deliverable to said customer in response to said notification.

13. The method of claim 12 further comprising:
entering a lot number identifying said deliverable.

14. The method of claim 12 further comprising:
receiving from said customer a machine readable indicia;
providing said machine readable indicia along with said deliverable to said customer.

15. The method of claim 14 wherein said machine readable indicia is a bar code.

16. The method of claim 12 wherein said deliverable is a good.

17. The method of claim 16 wherein said good is a raw material used in a manufacturing process.

18. The method of claim 12 wherein said deliverable is a service.

19. The method of claim 12 further comprising:
submitting a purchase order number to said customer via said network;
receiving a list of deliverables from said customer;
selecting from said list of deliverables said deliverable to be sent to said customer.

20. A system for obtaining certificate of analysis data from a supplier providing a deliverable to a customer, the system comprising:
a customer system for receiving a request to submit a certificate of analysis data corresponding to a deliverable;
said customer system obtaining certificate of analysis data corresponding to said deliverable;
a database containing a predefined specification;
said customer system comparing said certificate of analysis data to said predefined specification;
said customer system authorizing delivery of said deliverable to said customer in response to said comparing.

21. The system of claim 20 further comprising:
wherein said customer system receives a lot number identifying said deliverable;
said customer system determines if said lot number corresponds to an already approved lot number stored in said database; and
said customer system authorizes delivery of said deliverable if said lot number corresponds to an already approved lot number.

22. The system of claim 20 wherein:
said customer system obtains certificate of analysis data by prompting said supplier to provide said certificate of analysis data.

23. The system of claim 20 wherein:
said customer system provides a machine readable indicia to said supplier upon authorizing delivery of said deliverable.

24. The system of claim 23 wherein said machine readable indicia is a bar code.

25. The system of claim 23 wherein:
said customer system reads said machine readable indicia upon receipt of said deliverable to confirm that said deliverable meets said predefined specification.

26. The system of claim 20 wherein said deliverable is a good.

27. The system of claim 24 wherein said good is a raw material used in a manufacturing process.

28. The system of claim 20 wherein said deliverable is a service.

29. The system of claim 20 wherein:
said customer system authorizes delivery of said deliverable if said certificate of analysis data does not meet said predefined specification and stores said certificate of analysis data in said database as out-of-specification data.

30. The system of claim 20 wherein:
said customer system receives a purchase order number;
said customer system provides a list of deliverables to the supplier in response to the purchase order number;
said customer system receives a deliverable selected by the supplier from the list of deliverables; and,
said customer system retrieves said predefined specification in response to said deliverable selected by the supplier.

31. A storage medium encoded with machine-readable computer program code for obtaining certificate of analysis data from a supplier providing a deliverable to a customer in a system including a customer system, a database coupled to the customer system and a supplier system coupled to the customer system by a network, the storage medium including instructions for causing the customer system to implement a method comprising:
receiving at the customer system a request to submit certificate of analysis data corresponding to a deliverable;
obtaining certificate of analysis data corresponding to said deliverable;
comparing said certificate of analysis data to a predefined specification; and,
authorizing delivery of said deliverable to said customer in response to said comparing.

32. The storage medium of claim 31 further comprising instructions for causing the customer system to implement:
receiving a lot number identifying said deliverable;
wherein said obtaining certificate of analysis data includes determining if said lot number corresponds to an already approved lot number; and
wherein said authorizing delivery of said deliverable occurs if said lot number corresponds to an already approved lot number.

33. The storage medium of claim 31 wherein:
said obtaining certificate of analysis data includes prompting said supplier to provide said certificate of analysis data.

34. The storage medium of claim 31 further comprising instructions for causing the customer system to implement:
providing a machine readable indicia to said supplier upon authorizing delivery of said deliverable.

35. The storage medium of claim 34 wherein said machine readable indicia is a bar code.

36. The storage medium of claim 34 wherein further comprising instructions for causing the customer system to implement:
reading said machine readable indicia upon receipt of said deliverable to confirm that said deliverable meets said predefined specification.

37. The storage medium of claim 31 wherein said deliverable is a good.

38. The storage medium of claim 37 wherein said good is a raw material used in a manufacturing process.

39. The storage medium of claim 31 wherein said deliverable is a service.

40. The storage medium of claim 31 further comprising instructions for causing the customer system to implement:
authorizing delivery of said deliverable if said certificate of analysis data does not meet said predefined specification and storing said certificate of analysis data as out-of-specification data.

41. The storage medium of claim 31 further comprising instructions for causing the customer system to implement:
receiving a purchase order number;
providing a list of deliverables to the supplier in response to the purchase order number;
receiving a deliverable selected by the supplier from the list of deliverables;
retrieving said predefined specification in response to said deliverable selected by the supplier.
